(19) United States
(12) Patent Application Publication
(10) Pub. No.: US 2015/0196881 A1
(43) Pub. Date: Jul. 16, 2015

(54) Top stirring implement for natural peanut butter

(71) Applicant: Robin R. Rabii, Schenectady, NY (US)

(72) Inventor: Robin R. Rabii, Schenectady, NY (US)

(21) Appl. No.: 14/594,861

(22) Filed: Jan. 12, 2015

Related U.S. Application Data
(60) Provisional application No. 61/926,875, filed on Jan. 13, 2014.

(51) Int. Cl. B01F 7/16; A23L 1/38; B01F 7/00

(52) U.S. Cl. CPC B01F 7/1605; B01F 7/00416; A23L 1/38; B01F 2215/0016; A23V 2002/00

(57) ABSTRACT

A lid-mounted stirring implement provides an external crank handle which drives the rotation of a central internal pin, which supports one or more distal stirring elements. By turning the handle, the user may stir and temporarily homogenize the nut butter or other contained product, while keeping the container sealed and unable to leak.

### CROSS-REFERENCE TO RELATED APPLICATIONS

This application claims the benefit of U.S. Provisional Application No. 61/926875, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to food product packaging accessories, and in particular to a lid-mounted stirring implement for natural nut butter, such as peanut butter, almond butter and other natural nut butters. The jar of nut butter most consumers are familiar with contains trace amounts of certain harmless chemicals, which are added by the product's manufacturer to preserve the homogeneity of the product after being mixed. The nut oil in the mixture tends to separate and rise to the top; these chemicals prevents that separation, but their addition to the mixture forfeits any claim by the manufacturer to a product that is organic or all-natural. Those consumers who prefer organic or all-natural nut butter must stir the contents of the jar each time it is used, costing a significant amount of time and effort. For those consumers with limited amounts of time to devote to the preparation of a sandwich for lunch or a snack, this is an important consideration. Also, the contents other than nut oil tend to be very dense and difficult to stir, making this task difficult for many consumers, particularly those who are female, elderly, or very young. For the first few times the jar is used, it is full or nearly full and the nut oil tends to splash or spill out of the jar when stirred, creating a mess, A lid-mounted stirring implement, which mechanically stirs the contents of the jar, would resolve this problem.

### SUMMARY OF THE INVENTION

Accordingly, the invention is directed to a lid-mounted stirring implement. The alternative lid features an external crank handle which drives the rotation of a central internal pin, which supports one or more distal stirring elements. By turning the handle, the user may stir and temporarily homogenize the nut butter or other contained product, while keeping the container sealed and unable to leak.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawings are included to provide a further understanding of the invention and are incorporated into and constitute a part of the specification. They illustrate one embodiment of the invention and, together with the description, serve to explain the principles of the invention.

FIG. 1 shows a side perspective view of the container element of the first exemplary embodiment, displaying the container 13 and the threads 13A.

FIG. 2 shows a side perspective view of the stirring element of the first exemplary embodiment, displaying the lid 10, the crank handle 11, the rotating pin 11A, the stirring element 12, and the rotating core 12A.

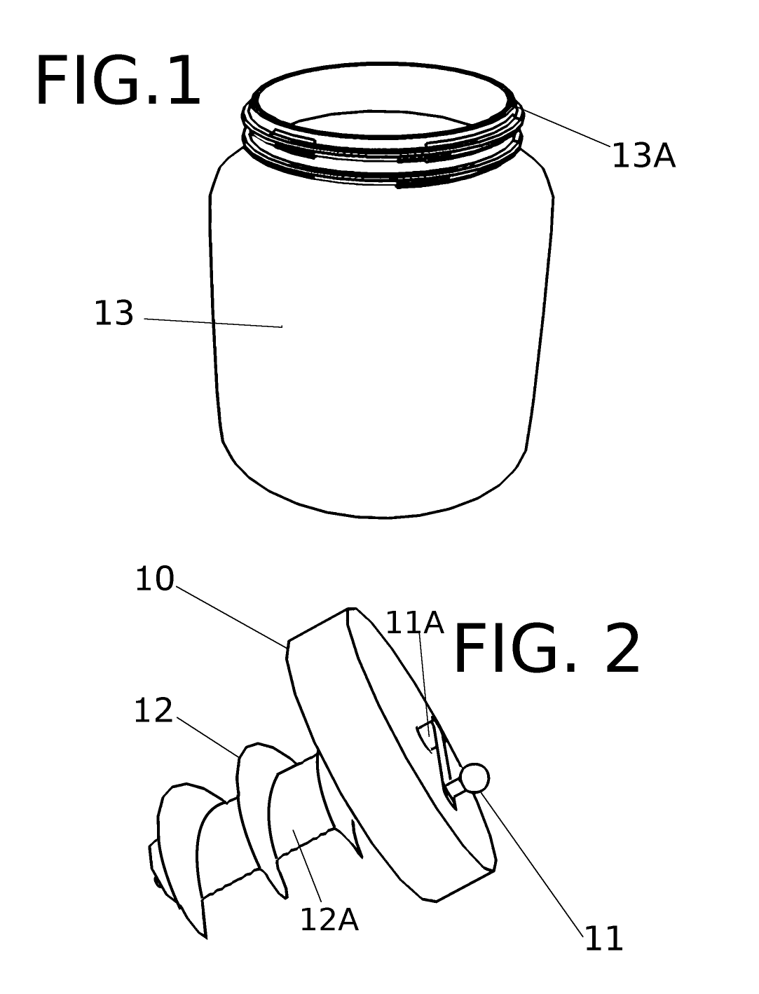

### DETAILED DESCRIPTION OF THE INVENTION

Referring now to the invention in more detail, the invention is directed to a lid-mounted stirring implement. The alternative lid 10 provides an external crank handle 11 which drives a rotating pin 11A. The rotating pin 11A is mounted centrally through the axis of the lid 10. The rotating pin 11A drives a rotating core 12A having attached distally thereto one or more distal stirring elements 12. By turning the handle 11, the user may stir and temporarily homogenize the nut butter or other contained product, while keeping the container 13 sealed and unable to leak.

The first exemplary embodiment is provided in several sizes, corresponding to all jar sizes and threaded lids used by major manufacturers of nut butter which is distributed in a target region, for example, North America. Although the device is intended for use with containers of nut butter, it is to be understood that this is not intended as a limiting factor of the invention. The device may be used with any product which is mixed and marketed in the form of a paste, liquid, or similar substance, and tends to separate into its components during storage.

The first exemplary embodiment provides a circular lid 10, which is preferably cylindrical, with a very short length in relation to its radius. The interior surface of the lid 10 is threaded, with a thread pattern which matches the threads 13A of containers 13 of commercially distributed nut butter and similar products, such that the lid 10 is releasably engageable to the container 13. At the center of the outer surface of the top of the lid 10, a crank handle 11 is provided. The crank handle 11 is affixed to a rotating pin 11A which, when turned by the crank handle 11, supports the rotation of the rotating core 12A one or more distal stirring elements 12. Preferably, a single screw-shaped stirring element 12 is provided, the action of which will agitate the contents of the container 13 when rotated by turning the crank handle 11.

The first exemplary embodiment is provided and intended for use as an alternative lid 10, replacing the lid 10 which is provided by the manufacturer of the nut butter or similar product, and capable of being removed, cleaned, and re-used on subsequent containers 13 when the first container 13 is empty. An alternate embodiment, which is intended to be installed by the manufacturer of the product as part of the original, pre-packaged container 13, is also contemplated.

To use the first exemplary embodiment, the user removes the lid which has been provided by the manufacturer on the container 13. The user then places the device on top of the container 13, such that the crank handle 11 extends upward and the stirring element 12 extends downward into the contents of the container 13, and turns the device to engage the threads of the device with the threads 13A of the container 13. The user then turns the device clockwise to create a tight seal. The user then grasps the crank handle 11 with one hand and the container 13 with the other hand, and turns the crank handle 11, rotating the stirring element 12 and mixing the contents of the container 13 until the desired level of homogeneity of the contents has been achieved. The user then turns the device counterclockwise to remove it from the container 13, and access the stirred contents.

The lid 10, the crank handle 11, and the stirring element 12 are preferably manufactured from a rigid, durable material which is easily cleaned, such as high-impact plastic. The internal pin is preferably manufactured from a rigid, durable material such as steel or aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A top stirring implement for a container comprising a container and a lid, said lid being releaseably engageable to said container; said lid being pierced centrally by a rotating pin; said rotating pin being affixed, above said lid, to a crank handle; and said rotating pin being engaged, below said lid, to a plurality of distal stirring elements.

2. The top stirring element for a container of claim 1 wherein said plurality of distal stirring elements are affixed to said rotating pin via a core.

3. The top stirring element for a container of claim 1 wherein said container is a container of commercially distributed nut butter and is exchangeable for other such containers.

4. The top stirring element for a container of claim 2 wherein said container is a container of commercially distributed nut butter and is exchangeable for other such containers.

5. The top stirring element for a container of claim 1 wherein said plurality of distal stirring elements comprises a single screw-shaped stirring element.

6. The top stirring element for a container of claim 2 wherein said plurality of distal stirring elements comprises a single screw-shaped stirring element.

7. The top stirring element for a container of claim 3 wherein said plurality of distal stirring elements comprises a single screw-shaped stirring element.

8. The top stirring element for a container of claim 4 wherein said plurality of distal stirring elements comprises a single screw-shaped stirring element.

9. A method of using an apparatus, the apparatus comprising:
a container and a lid, said lid being releaseably engageable to said container; said lid being pierced centrally by a rotating pin; said rotating pin being affixed, above said lid, to a crank handle; said rotating pin being engaged, below said lid, to a plurality of distal stirring elements; and said container containing a quantity of nut butter, the oil component of said quantity of nut butter having separated out;
and the method comprising:
engaging said lid to said container; turning said crank handle such that said distal stirring elements are urged to rotate; and continuing until said quantity of nut butter has been homogenized.

10. The method of using an apparatus of claim 9 wherein said plurality of distal stirring elements are affixed to said rotating pin via a core.

11. The method of using an apparatus of claim 9 wherein said container is a container of commercially distributed nut butter and is exchangeable for other such containers.

12. The method of using an apparatus of claim 10 wherein said container is a container of commercially distributed nut butter and is exchangeable for other such containers.

13. The method of using an apparatus of claim 9 wherein said plurality of distal stirring elements comprises a single screw-shaped stirring element.

14. The method of using an apparatus of claim 10 wherein said plurality of distal stirring elements comprises a single screw-shaped stirring element.

15. The method of using an apparatus of claim 11 wherein said plurality of distal stirring elements comprises a single screw-shaped stirring element.

16. The method of using an apparatus of claim 12 wherein said plurality of distal stirring elements comprises a single screw-shaped stirring element.
